(19) United States
(12) Patent Application Publication
(10) Pub. No.: US 2024/0329576 A1
(43) Pub. Date: Oct. 3, 2024

(54) ROLLER, FIXING DEVICE, MEDIUM ADJUSTMENT DEVICE, AND IMAGE FORMING APPARATUS

(71) Applicant: FUJIFILM Business Innovation Corp., Tokyo (JP)

(72) Inventors: Yuka NOMURA, Kanagawa (JP); Koji Yoshitsugu, Kanagawa (JP); Yasuhisa Gonda, Kanagawa (JP)

(73) Assignee: FUJIFILM Business Innovation Corp., Tokyo (JP)

(21) Appl. No.: 18/358,018

(22) Filed: Jul. 24, 2023

(30) Foreign Application Priority Data
Mar. 28, 2023 (JP) 2023-052089

(51) Int. Cl. G03G 15/20

(52) U.S. Cl. CPC G03G 15/2053; G03G 15/2028

(57) ABSTRACT

A cylindrical roller that is used by being rotated includes a heat dissipator having a tubular dense structure and disposed in at least a portion within an internal space of the roller in a state where the heat dissipator is in contact with an inner peripheral surface of the internal space.

### CROSS-REFERENCE TO RELATED APPLICATIONS

This application is based on and claims priority under 35 USC 119 from Japanese Patent Application No. 2023-052089 filed Mar. 28, 2023.

### BACKGROUND

### (i) Technical Field

The present disclosure relates to rollers, fixing devices, medium adjustment devices, and image forming apparatuses.

### (ii) Related Art

For example, Japanese Unexamined Patent Application Publication No. 2005-234205 (paragraph [0050], FIGS. 2 and 3) describes a known technology related to a roller having a heat dissipating function.

Japanese Unexamined Patent Application Publication No. 2005-234205 (paragraph [0050], FIGS. 2 and 3) describes, for example, a cooling roller having multiple tabular radiator fins on the inner peripheral surface of a cylindrical roller. The radiator fins extend parallel to the axial direction and are arranged at a predetermined pitch along the inner peripheral surface.

### SUMMARY

Aspects of non-limiting embodiments of the present disclosure relate to cooling a rotating cylindrical roller with ensured quietness even if the roller increases in temperature as a result of receiving heat during the rotation thereof, as compared with a case where a heat dissipator having a tubular dense structure is not disposed in at least a portion within an internal space of the roller in a state where the heat dissipator is in contact with the inner peripheral surface of the internal space.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a cylindrical roller that is used by being rotated, the roller comprising: a heat dissipator having a tubular dense structure and disposed in at least a portion within an internal space of the roller in a state where the heat dissipator is in contact with an inner peripheral surface of the internal space.

### BRIEF DESCRIPTION OF THE DRAWINGS

Exemplary embodiments of the present disclosure will be described in detail based on the following figures, wherein:

FIG. 1 schematically illustrates an image forming apparatus according to a first exemplary embodiment;

FIG. 2 schematically illustrates a part (i.e., a fixing device equipped with a pressing rotation roller having heat dissipators) of the image forming apparatus in FIG. 1;

FIG. 3A is a schematic side view of the pressing rotation roller according to the first exemplary embodiment, and FIG. 3B is a schematic end view of the pressing rotation roller taken along line IIIB-IIIB in FIG. 3A;

FIG. 4 includes a schematic end view of the pressing rotation roller taken along line IV-IV in FIG. 3B and a graph indicating a surface temperature of the roller;

FIG. 5A is a schematic front view of each heat dissipator, FIG. 5B is a schematic side view of the heat dissipator in FIG. 5A, and FIG. 5C is a schematic end view of the heat dissipator taken along line VC-VC in FIG. 5A;

FIG. 6A is a schematic perspective view of tubular bodies constituting a tubular dense structure of each heat dissipator, and FIG. 6B is a schematic side view of each tubular body in FIG. 6A;

FIG. 7 schematically illustrates an operating state related to cooling of the pressing rotation roller in the fixing device in FIG. 2;

FIG. 8 is a schematic end view of a roller according to a second exemplary embodiment;

FIG. 9 is a schematic end view of a roller according to a third exemplary embodiment;

FIG. 10 schematically illustrates an uncurling device as an example of a medium adjustment device according to a fourth exemplary embodiment; and

FIG. 11 schematically illustrates a medium cooling device as another example of a medium adjustment device according to a fifth exemplary embodiment.

### DETAILED DESCRIPTION

Exemplary embodiments of the present disclosure will be described below.

### First Exemplary Embodiment

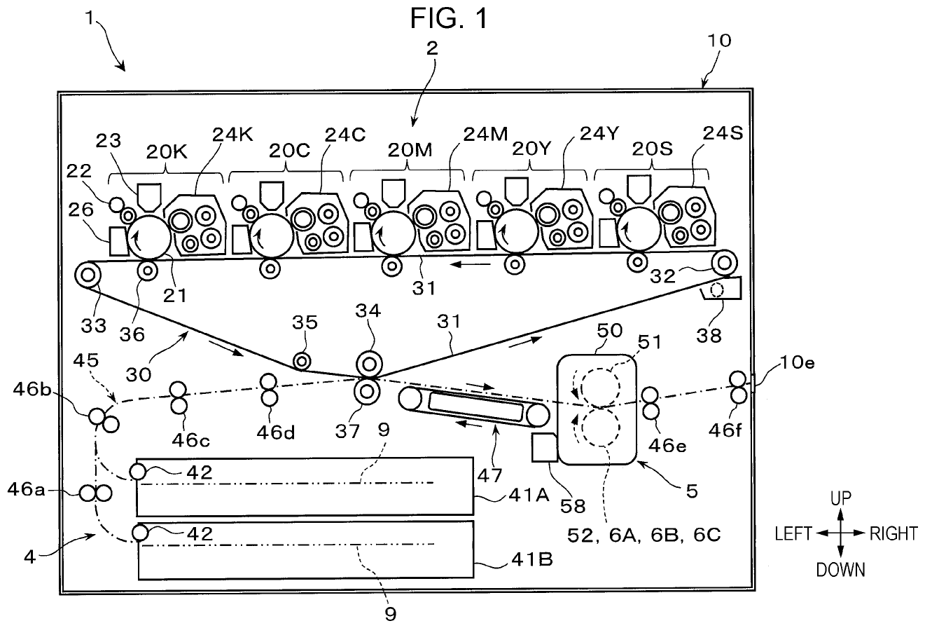

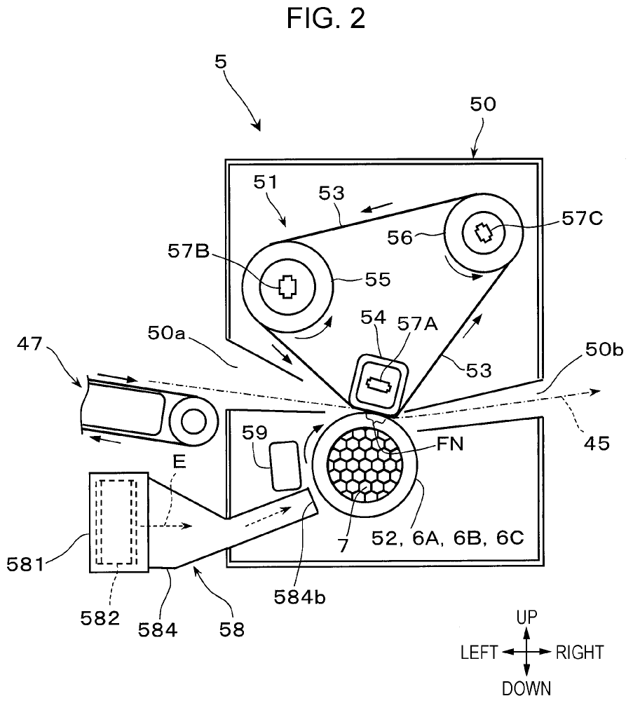

FIG. 1 schematically illustrates an image forming apparatus according to a first exemplary embodiment of the present disclosure. FIG. 2 schematically illustrates a fixing device in the image forming apparatus in FIG. 1.

In this description and the drawings, substantially identical components will be given the same reference signs, and redundant descriptions of such identical components will be omitted in this description.

### 1.1. Configuration of Image Forming Apparatus

As shown in FIG. 1, an image forming apparatus 1 forms an image onto recording paper 9 as an example of a recording medium. For example, the image forming apparatus 1 is connectable to an external apparatus, such as an information terminal, and is capable of forming an image corresponding to image information input therefrom.

As shown in FIG. 1, the image forming apparatus 1 includes an image forming section 2, a medium feeding device 4, a fixing device 5, and a controller (not shown) that are provided within an internal space of a housing 10.

The housing 10 is a box-shaped structure formed into a predetermined external shape by using a structural component, such as a frame, and cover components, such as a panel and an openable-closable door. In FIG. 1, a single-dot chain line denotes a transport path 45 along which the recording paper 9 is transported within the housing 10.

The image forming section 2 is where unfixed images are formed and are transferred onto the recording paper 9. The image forming section 2 includes image forming units 20 that form unfixed images and an intermediate transfer unit 30 that relays and transfers the unfixed images formed at the image forming units 20 onto the recording paper 9.

The image forming units 20 are a group of units configured to form toner images formed of toners serving as developers based on the image information.

The image forming units 20 according to the first exemplary embodiment include image forming units 20Y, 20M, 20C, 20K, and 20S (sometimes abbreviated as 20 (Y, M, C, K, S) hereinafter) that independently and dedicatedly form toner images of, for example, yellow (Y), magenta (M), cyan (C), black (K), and special (S) colors. The special color (S) is, for example, a white color or a transparent color.

The image forming units 20Y, 20M, 20C, 20K, and 20S have substantially similar configurations except for the fact that the colors of developers (i.e., toners in this example) respectively used in developing devices 24 and abbreviated as Y, M, C, K, and S are different from one another.

Specifically, the image forming units 20 (Y, M, C, K, S) each have a photoconductor drum 21 as an example of a latent-image bearing member on which a latent image is formed and retained. In each of the image forming units 20 (Y, M, C, K, S), the photoconductor drum 21 is surrounded by devices, such as a charging device 22, an exposure device 23, a developing device 24 (Y, M, C, K, S), a first-transfer device 36, and a drum cleaning device 26.

When the image forming apparatus 1 is viewed from the front surface, the image forming units 20 (Y, M, C, K, S) are arranged in series at a predetermined pitch in the left-right direction within the internal space of the housing 10. The front surface is treated as the surface at the front side of the image forming apparatus 1.

In FIG. 1, the photoconductor drum 21, the charging device 22, the exposure device 23, the developing device 24K, the first-transfer device 36, and the drum cleaning device 26 in the image forming unit 20K are given their respective reference signs. In FIG. 1, for the remaining image forming units 20 (Y, M, C, S), only the developing devices 24 (Y, M, C, S) are given their respective reference signs, whereas other reference signs are omitted.

The photoconductor drum 21 is a drum-shaped photoconductor that extends in the front-rear direction and that rotates in a direction indicated by an arrow around a rotation axis (not shown).

The charging device 22 electrostatically charges the outer peripheral surface serving as an image forming surface of the photoconductor drum 21 to a predetermined surface potential. The charging device 22 includes a charging member, such as a charging roller, which is in contact with an image forming region on the outer peripheral surface of the photoconductor drum 21 and which is supplied with a charging current.

The exposure device 23 exposes the electrostatically-charged outer peripheral surface of the photoconductor drum 21 to light based on the image information so as to form an electrostatic latent image thereon.

The developing device 24 turns the electrostatic latent image formed on the outer peripheral surface of the photoconductor drum 21 into a toner image as an example of an unfixed image by developing the electrostatic latent image using a developer of the corresponding predetermined color (i.e., any one of the Y, M, C, K, and S colors).

The first-transfer device 36 transfers the toner image formed on the outer peripheral surface of the photoconductor drum 21 in each image forming unit 20 (Y, M, C, K, S) onto an intermediate transfer belt 31 of the intermediate transfer unit 30. The first-transfer device 36 includes a transfer member, such as a transfer roller, which is in contact with the outer peripheral surface of the photoconductor drum 21 and which is supplied with a first-transfer current. If the intermediate transfer unit 30 is employed, the first-transfer device 36 is treated as one component included in the intermediate transfer unit 30.

The drum cleaning device 26 cleans the outer peripheral surface of the photoconductor drum 21 by removing waste, such as unwanted toner and paper particles, from the outer peripheral surface of the photoconductor drum 21.

The intermediate transfer unit 30 is a group of devices that temporarily retain the toner images formed at the image forming units 20 (Y, M, C, K, S) on an intermediate transfer body and that subsequently transfer the toner images onto the recording paper 9.

The intermediate transfer unit 30 includes, for example, the intermediate transfer belt 31 as an example of an intermediate transfer body, support rollers 32 to 35 that rotatably support the intermediate transfer belt 31 from the inner peripheral surface, the first-transfer devices 36, a second-transfer device 37, and a belt cleaning device 38. The intermediate transfer unit 30 is disposed at a position located below the image forming units 20 (Y, M, C, K, S) within the internal space of the housing 10.

The intermediate transfer belt 31 is a ring-shaped strip-like belt having a predetermined width and a predetermined length and has an outer peripheral surface that is capable of retaining toner images in accordance with an electrostatic effect.

The support rollers 32 to 35 support the intermediate transfer belt 31 in a substantially inverted-triangular shape and in a rotatable manner in a direction indicated by an arrow.

The support rollers 32 and 33 support the intermediate transfer belt 31 in such a manner as to form a transfer surface extending planarly in the left-right direction via the photoconductor drums 21 of the image forming units 20 (Y, M, C, K, S). The support roller 32 is, for example, a driving roller that applies a driving force for rotating the intermediate transfer belt 31.

The support roller 34 is a second-transfer back roller that supports the inner peripheral surface of the intermediate transfer belt 31 facing the second-transfer device 37. The support roller 35 is, for example, a tension roller that applies a predetermined tension to the intermediate transfer belt 31.

Each first-transfer device 36 is disposed to press the intermediate transfer belt 31 against an area where the photoconductor drum 21 of the corresponding image forming unit 20 (Y, M, C, K, S) performs a first-transfer process.

The second-transfer device 37 transfers the toner images first-transferred on the outer peripheral surface of the intermediate transfer belt 31 onto the recording paper 9. The second-transfer device 37 includes transfer members, such as a transfer roller and a transfer transport belt, which are in contact with the outer peripheral surface of the intermediate transfer belt 31 supported by the support roller 34 and which are supplied with a second-transfer current.

The belt cleaning device 38 cleans the outer peripheral surface of the intermediate transfer belt 31 by removing waste, such as unwanted toner and paper particles, from the outer peripheral surface of the intermediate transfer belt 31.

The medium feeding device 4 accommodates and feeds the recording paper 9 as an example of a recording medium to be fed to a second-transfer position of the intermediate transfer unit 30. For example, the medium feeding device 4 is disposed at a position located below the intermediate transfer unit 30 within the internal space of the housing 10.

The medium feeding device 4 includes containers 41A and 41B that accommodate the recording paper 9 and a delivery device 42 that delivers the recording paper 9 one-by-one from each of the containers 41A and 41B. The recording paper 9 is a medium cut to a predetermined size. The number of containers 41 is not particularly limited.

The fixing device 5 fixes the unfixed toner images second-transferred and retained on the recording paper 9 at the intermediate transfer unit 30 onto the recording paper 9. For example, the fixing device 5 is disposed at a position located diagonally below one side of the intermediate transfer unit 30 within the internal space of the housing 10. The fixing device 5 will be described in detail later.

The transport path 45 includes a path extending from the containers 41A and 41B of the medium feeding device 4 to the fixing device 5 via an area where the intermediate transfer unit 30 performs a second-transfer process, and a path ultimately extending from the fixing device 5 to a medium outlet 10e of the housing 10.

The transport path 45 has disposed thereon, for example, multiple pairs of transport rollers 46a, 46b, 46c, 46d, 46c, and 46f, a suction belt transport device 47, and a transport guide member (not shown). The suction belt transport device 47 is disposed within a path connecting between the area where the intermediate transfer unit 30 performs the second-transfer process and the fixing device 5.

An output section (not shown) that accommodates the recording paper 9 output from the medium outlet 10e is provided outside the housing 10. Examples of the output section include a container tray that accommodates the output recording paper 9 and a post-processing device that performs predetermined processing on the output recording paper 9.

### 1.2. Operation of Image Forming Apparatus

In the image forming apparatus 1, when the controller (not shown) receives an operation command for forming an image from, for example, an external apparatus, the following series of basic image forming operation is performed.

First, in the image forming section 2 of the image forming apparatus 1, any one of the image forming units 20 (Y, M, C, K, S) executes a charging operation, an exposure operation, a developing operation, and a cleaning operation, and the intermediate transfer unit 30 of the image forming section 2 executes a first-transfer operation and a second-transfer operation. On the other hand, in the image forming apparatus 1, a feeding operation of the recording paper 9 is executed at the medium feeding device 4 and the transport path 45.

Accordingly, in the image forming section 2, a toner image is formed on the photoconductor drum 21 of any one of the image forming units 20 (Y, M, C, K, S). Then, the toner image is first-transferred onto the intermediate transfer belt 31 of the intermediate transfer unit 30 and is subsequently second-transferred onto the recording paper 9.

Subsequently, in the image forming apparatus 1, the recording paper 9 having the toner image second-transferred thereon at the intermediate transfer unit 30 of the image forming section 2 is guided and transported to the fixing device 5 in accordance with a transport operation along the transport path 45, and then undergoes a fixing operation at the fixing device 5.

Accordingly, the unfixed toner image is fixed onto the recording paper 9.

The recording paper 9 having undergone the fixing operation is transported in accordance with the transport operation along the transport path 45, and is subsequently output to the output section (not shown) disposed outside the housing 10.

1 Accordingly, in the image forming apparatus 1, the basic image forming operation involving forming an image formed of toner onto one face of a single sheet of recording paper 9 is completed.

In this case, for example, if the image forming operation is performed at all of the image forming units 20 (Y, M, C, K), a so-called full color image constituted of toner images of four colors (Y, M, C, and K) is formed. Furthermore, in the image forming apparatus 1, a toner image of the special color (S) is formable by performing the image forming operation at the image forming unit 20S, where appropriate.

### 1.3. Configuration of Fixing Device

As shown in FIG. 2, the fixing device 5 has devices, such as a heating rotating body 51 and a pressing rotation roller 52, disposed within an internal space of a box-shaped housing 50 provided with an inlet 50a and an outlet 50b for the recording paper 9.

As shown in FIG. 2, the heating rotating body 51 is a belt-pad-type rotating body. The belt-pad-type heating rotating body 51 includes, for example, an endless fixing belt 53, a presser body 54 that supports the fixing belt 53 from the inner peripheral surface thereof and that presses the outer peripheral surface thereof against the pressing rotation roller 52, and multiple support rollers 55 and 56 that rotatably support the fixing belt 53 in cooperation with the presser body 54.

The presser body 54 and the support rollers 55 and 56 are heated and maintained at a predetermined temperature, such as a fixation temperature, by heaters 57A, 57B, and 57C, such as electrical heaters, disposed therein. The support roller 55 is a driving roller driven by receiving a rotational driving force from a driving device (not shown), and rotates the fixing belt 53 in a direction indicated by an arrow. Furthermore, the support roller 56 is an adjustment roller that applies a predetermined tension to the fixing belt 53 and that moves to correct meandering of the fixing belt 53.

The presser body 54 and the support rollers 55 and 56 are supported by a support frame (not shown).

The pressing rotation roller 52 is disposed such that the fixing belt 53 of the heating rotating body 51 is pressed against the presser body 54 with a predetermined pressure by a pressing mechanism (not shown).

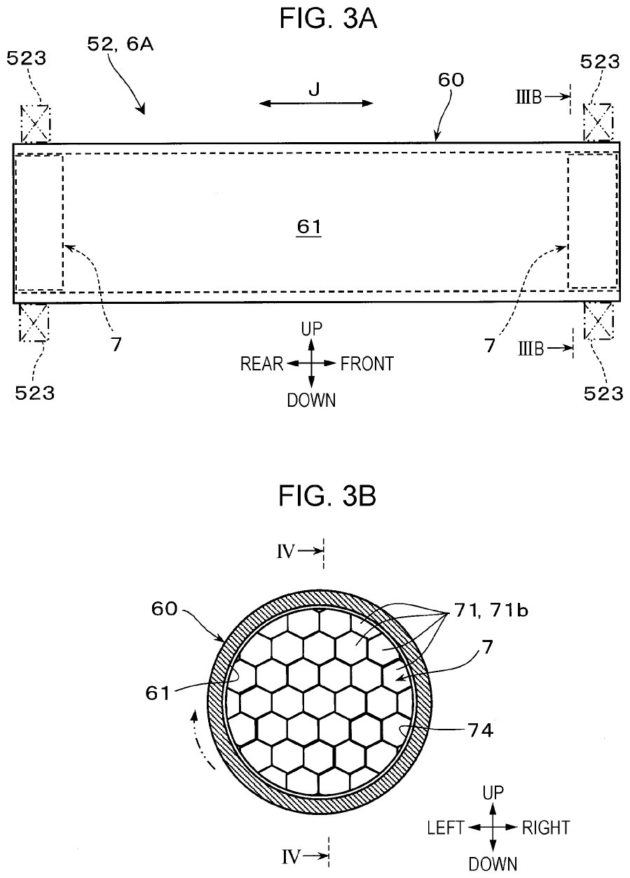

As shown in FIGS. 3A and 3B, the pressing rotation roller 52 includes a cylindrical roller 6A having a cylindrical roller body 60 composed of, for example, metal. The roller 6A may be provided with a layer on the outer peripheral surface of the roller body 60. The roller 6A serving as the pressing rotation roller 52 is provided with, for example, an elastic layer (not shown) composed of rubber or synthetic resin on the outer peripheral surface of the roller body 60.

The roller 6A will be described in detail later.

As shown in FIGS. 3A and 3B, the pressing rotation roller 52 including the roller 6A is provided such that the opposite ends of the roller body 60 in an axial direction J are supported in a rotatable manner by a support frame (not shown) with bearings 523 interposed therebetween. The pressing rotation roller 52 is disposed such that the fixing belt 53 of the heating rotating body 51 is pressed against the presser body 54 with a predetermined pressure by the pressing mechanism (not shown).

The pressing rotation roller 52 is supported by the aforementioned support frame in such a manner as to move into and out of contact with a portion of the fixing belt 53 supported by the presser body 54. For example, when the image forming operation is not performed, the pressing rotation roller 52 is set in the non-contact state.

Furthermore, the pressing rotation roller 52 is rotationally driven in a direction indicated by an arrow by receiving a rotational driving force from a driving device (not shown). The surface temperature of the pressing rotation roller 52 is measured by a temperature measuring device 59.

In the fixing device 5, a contact section where the heating rotating body 51 and the pressing rotation roller 52 are in contact with each other serves as a fixing section (i.e., a so-called fixation nip) FN where, for example, heating and pressing are performed for fixing the unfixed toner image onto the recording paper 9. The aforementioned contact section is specifically a section where the fixing belt 53 and the pressing rotation roller 52 are in contact with each other.

### 1.4. Operation of Fixing Device

In the image forming apparatus 1, when a timing for performing the above-described image forming operation is reached, the fixing device 5 performs the following fixing operation.

First, in the heating rotating body 51 of the fixing device 5, the support roller 55 serving as a driving roller is driven, so that the fixing belt 53 starts rotating in the direction indicated by the arrow to revolve around the presser body 54 and the support rollers 55 and 56. Furthermore, in the heating rotating body 51, the heaters 57A, 57B, and 57C are actuated, so that the presser body 54 and the support rollers 55 and 56 are heated.

On the other hand, in the fixing device 5, the pressing rotation roller 52 starts rotating in the direction indicated by the arrow to cause the fixing belt 53 to pass the presser body 54 while being in pressure contact therewith.

Accordingly, in the fixing device 5, the fixing belt 53 in a heated and pressed state rotates to pass through the fixing section FN. In this case, the pressing rotation roller 52 rotates while being in contact with the heated fixing belt 53.

Then, in the fixing device 5, the recording paper 9 having the toner image second-transferred thereon at the intermediate transfer unit 30 is guided to and passed through the fixing section FN.

As a result, the toner image and the recording paper 9 are heated while being pressed in the process of passing through the fixing section FN, whereby the toner image is ultimately fused and fixed onto the recording paper 9.

Accordingly, the fixing operation for fixing the toner image onto the single sheet of recording paper 9 is completed.

### 1.5. Configuration Related to Cooling of Pressing Rotation Roller

In the fixing device 5, when a timing for performing the fixing operation is reached, the pressing rotation roller 52 rotates while being in contact with the heated fixing belt 53, so that the pressing rotation roller 52 receives heat from the fixing belt 53.

Accordingly, the temperature at the outer peripheral surface of the pressing rotation roller 52 may sometimes increase more than necessary, as compared with when the fixing device 5 is stopped (i.e., before the fixing device 5 is actuated).

Therefore, the fixing device 5 employs the following configuration for cooling the pressing rotation roller 52. This cooling-related configuration involves employing both the roller 6A, serving as the pressing rotation roller 52, having heat dissipators 7 with a tubular dense structure, as shown in FIGS. 2 to 4, and an air blower 58 that cools the pressing rotation roller 52 by blowing air thereto, as shown in FIGS. 1 and 2.

Roller Having Heat Dissipators with Tubular Dense Structure

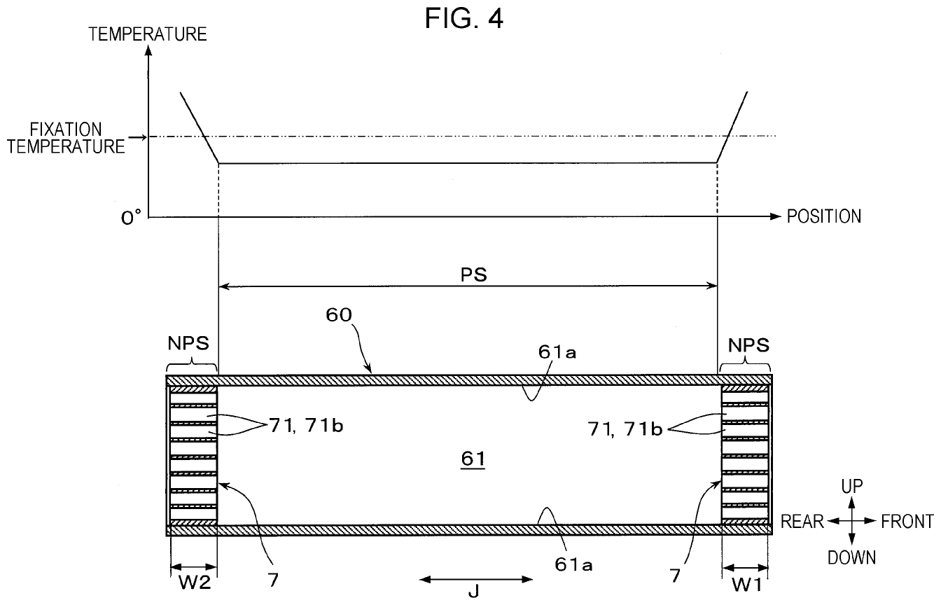

As shown in FIGS. 3A to 4, the roller 6A serving as the pressing rotation roller 52 includes the heat dissipators 7 having the tubular dense structure that are disposed in at least a portion within an internal space 61 of the cylindrical roller body 60 in a state where the heat dissipators 7 are in contact with an inner peripheral surface 61a of the internal space 61.

The cylindrical roller body 60 is a cylinder having openings at the opposite ends thereof in the axial direction J, or is a tubular structure resembling such a cylinder. The roller body 60 is composed of metal, such as stainless steel.

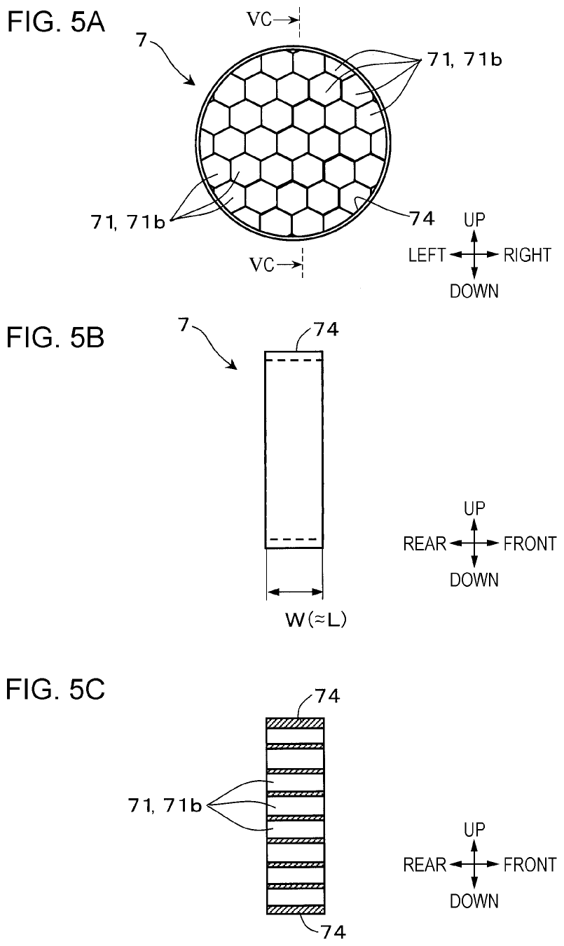

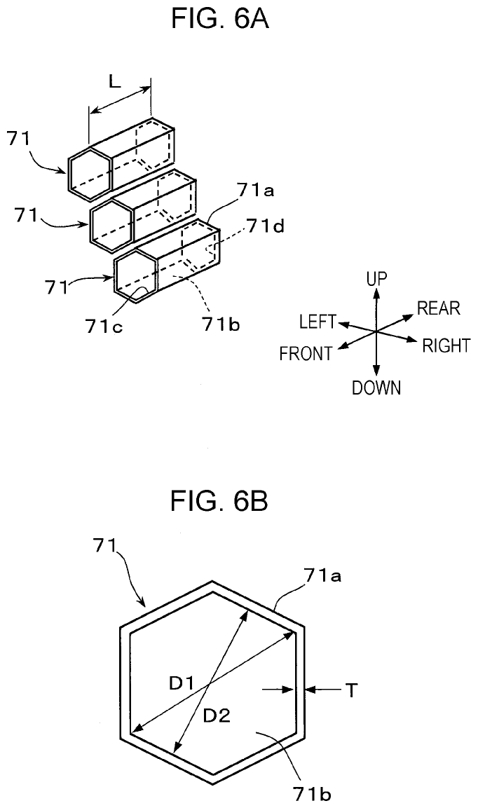

As shown in FIGS. 5A to 6B, the tubular dense structure has multiple tubular bodies 71 each having a through-space 71b with openings at the opposite ends thereof, and has an external appearance in which the tubular bodies 71 are densely grouped with the extending directions of the through-spaces 71b being aligned with one another.

In other words, the tubular dense structure is a structure in which the multiple tubular bodies 71 are combined in a densely arranged fashion or a structure in which the multiple tubular bodies 71 externally appear as if they densely exist.

If each of the tubular bodies 71 in the tubular dense structure is treated as an independent unit, the tubular body 71 is a structure having a frame 71a surrounding the through-space 71b, as shown in FIGS. 6A and 6B.

If the tubular dense structure is a structure in which the multiple tubular bodies 71 externally appear as if they densely exist, the tubular bodies 71 may be treated as structural parts that form boundaries between portions (through-portions) appearing like adjacent tubular bodies 71.

Therefore, as shown in FIG. 6A, the through-spaces 71b in the tubular bodies 71 as independent units and the through-spaces 71b in portions appearing as if the tubular bodies 71 exist may each be regarded as a tubular hole having end openings 71c and 71d at the opposite ends thereof.

Each tubular body 71 has a predetermined cross-sectional shape and has a predetermined length L. Each through-space 71b has the predetermined cross-sectional shape and has the predetermined length L.

The cross-sectional shape of each tubular body 71 or each through-space 71b is, for example, a polygonal shape, such as a regular hexagonal shape, a rhombic shape, or a triangular shape, a circular shape, or an elliptical shape.

If the tubular dense structure is a structure in which the multiple tubular bodies 71 are combined in a densely arranged fashion, the tubular dense structure may have gaps different in shape from the through-spaces 71b between adjacent tubular bodies 71.

The tubular dense structure includes a honeycomb structure.

A honeycomb structure may be regarded as having an external appearance in which the tubular bodies 71 that are regular hexagonal in cross section, as shown in FIG. 6A, are densely arranged in an orderly fashion without gaps, as shown in FIGS. 5A to 5C.

As shown in FIGS. 5A to 5C, each heat dissipator 7 having the tubular dense structure includes a part (i.e., body) where the tubular bodies 71 are densely arranged and a ring-shaped outer peripheral body 74 that surrounds the outer periphery of the aforementioned part.

From the standpoint of achieving an efficient heat dissipating function, the heat dissipators 7 are composed of metal with higher thermal conductivity than the inner peripheral surface 61a of the internal space 61 of the roller body 60. Metal with high thermal conductivity may be aluminum.

The heat dissipators 7 having the tubular dense structure are respectively disposed at the opposite ends within the internal space 61 of the roller body 60 in the axial direction J. Accordingly, the heat dissipators 7 may readily come into contact with the air outside the roller body 60, as compared with a case where a heat dissipator 7 is disposed in an inner area, such as the center, within the internal space 61 in the axial direction J.

As shown in FIG. 4, with regard to the roller 6A serving as the pressing rotation roller 52, the heat dissipators 7 may be respectively disposed at the opposite ends within the internal space 61 that correspond to non-passing sections NPS through which the recording paper 9 does not pass in contact with the pressing rotation roller 52 during the fixing operation.

The location where each heat dissipator 7 is disposed in the roller 6A serving as the pressing rotation roller 52 will be described in detail later.

First, as shown in FIG. 4, during the fixing operation, a passing section PS through which the recording paper 9 passes in contact therewith and the non-passing sections NPS through which the recording paper 9 does not pass in contact therewith occur on the pressing rotation roller 52 of the fixing device 5.

In a center-registration medium transport method involving transporting the recording paper 9 with reference to the center in the width direction intersecting the transport direction along the transport path 45, the non-passing sections NPS are sections located outward of the passing section PS from the opposite ends thereof in the axial direction J. The non-passing sections NPS shown in FIG. 4 are sections occurring when the passing recording paper 9 has the maximum width when being transported.

As shown in FIG. 4, the pressing rotation roller 52 is such that the temperature of the outer peripheral surface thereof at the non-passing sections NPS is higher than the temperature of the outer peripheral surface at the passing section PS.

This is because the recording paper 9 undergoing the fixing operation absorbs heat as the recording paper 9 passes through the passing section PS in contact therewith, whereas the non-passing sections NPS do not experience heat absorption by the recording paper 9 and thus becomes relatively higher in temperature.

This temperature variation in the axial direction J becomes more prominent with increasing number of consecutive passing sheets of recording paper 9 of the same widthwise size.

Therefore, from the standpoint of preferentially and efficiently cooling the non-passing sections NPS that are relatively higher in temperature, the roller 6A serving as the pressing rotation roller 52 has the heat dissipators 7 disposed at the opposite ends within the internal space 61 of the roller body 60 that correspond to the non-passing sections NPS on the pressing rotation roller 52.

With regard to the non-passing sections NPS, non-passing sections NPS occurring when the passing recording paper 9 has a width smaller than the maximum width when being transported may be selected. The recording paper 9 having the smaller width in this case may be selected recording paper having a width that has a relatively high possibility of being used in consecutive image forming operations, that is, consecutive fixing operations.

If such non-passing sections NPS are selected, a wrinkle, to be described below, may be suppressed. Specifically, after the recording paper 9 with a width smaller than the maximum width undergoes consecutive fixing operations, if another recording paper 9 with a width larger than the recording paper 9 with the smaller width undergoes a fixing operation, the recording paper 9 with the larger width may sometimes become wrinkled due to a temperature variation in the axial direction J. Such an occurrence of a wrinkle may be suppressed.

The heat dissipators 7 in the pressing rotation roller 52 may be disposed slightly inward of the passing section PS so long as the heat dissipators 7 are disposed at the opposite ends, corresponding to the non-passing sections NPS, within the internal space 61 of the roller body 60 in the axial direction J.

A width W of each heat dissipator 7 in the axial direction J is set in correspondence with, for example, the width of the location where the heat dissipator 7 is disposed, such as the width of the corresponding non-passing section NPS in the axial direction J.

Widths W1 and W2 (see FIG. 4) of the heat dissipators 7 respectively disposed at the opposite ends within the internal space 61 of the roller body 60 of the roller 6A serving as the pressing rotation roller 52 may be equal to each other or may be different from each other.

Furthermore, from the standpoint of, for example, ensuring a large surface area for enhancing the heat dissipating function, the heat dissipators 7 having the tubular dense structure may have a larger number of tubular bodies 71.

Therefore, as shown in FIGS. 6A and 6B, each tubular body 71 may have relatively small openings (inner diameter D), and the frame 71a thereof may have a relatively small thickness T. The opening of the tubular body 71 shown in FIG. 6B has a regular hexagonal shape with a maximum inner diameter D1 and a minimum inner diameter D2.

As an example, assuming that the internal space 61 of the roller 6A serving as the pressing rotation roller 52 has an inner diameter of about 25 mm and the heat dissipators 7 with the honeycomb structure shown in FIGS. 5A to 5C are disposed, the minimum inner diameter D2 of each tubular body 71 serving as a honeycomb portion ranges between 3 mm and 8 mm, and the thickness T of the tubular body 71 ranges between 20 μm and 80 μm.

In the heat dissipators 7 having the honeycomb structure according to this assumption, the compression strength thereof preferably ranges between 20 kgf/cm² and 21 kgf/cm². The compression strength is the strength relative to the direction of the length L of the tubular body 71 and includes the strength of the outer peripheral body 74.

For example, the heat dissipators 7 having the tubular dense structure may each be fabricated by combining multiple tubular bodies 71 as independent units in a densely arranged fashion, or may be fabricated by using a honeycomb manufacturing method.

The outer peripheral body 74 of each heat dissipator 7 is fabricated separately from the heat dissipator 7 and is subsequently combined with the heat dissipator 7.

The heat dissipators 7 are attached by being fitted and secured to the internal space 61 of the roller 6A or by being secured to the inner peripheral surface 61a of the internal space 61 by bonding using, for example, an adhesive.

Air Blower

As shown in FIG. 2, the air blower 58 includes a blower body 581 that generates air E to be blown, and a blower duct 584 that guides the air E released from the blower body 581 and blows the air E toward a predetermined target.

The blower body 581 is a part that generates air to be blown.

The blower body 581 according to the first exemplary embodiment is disposed outside the housing 50 of the fixing device 5, and includes a driving unit 582 having rotating fans and a cover member (not shown) that covers the driving unit 582.

The blower body 581 is disposed outside the housing 50 at a position located near a lower area of the side surface provided with the inlet 50a for the recording paper 9. In other words, the blower body 581 is disposed at a position located between the second-transfer area of the intermediate transfer unit 30 and the fixing device 5.

For example, the driving unit 582 is disposed such that three rotating fans thereof are arranged in the axial direction J of the pressing rotation roller 52. The cover member (not shown) has an intake port and a discharge port.

The blower duct 584 has one end connected to the discharge port of the blower body 581 and the other end disposed to extend into the housing 50 of the fixing device 5.

The tip of the other end is provided with a blower port 584b from which air is blown. The blower port 584b is, for example, a rectangular opening extending in the axial direction J of the pressing rotation roller 52.

The air blower 58 is configured to blow the air E (see FIG. 2) generated in the blower body 581 onto the pressing rotation roller 52 via the blower duct 584.

In detail, as shown in FIG. 2, the blower duct 584 is designed to blow the air E directly onto an area extending in the axial direction J on the outer peripheral surface of the pressing rotation roller 52 from the blower port 584b.

### 1.6. Operation Related to Cooling of Pressing Rotation Roller

In the fixing device 5, when a timing for performing the above-described image forming operation is reached, the following cooling operation is performed on the pressing rotation roller 52.

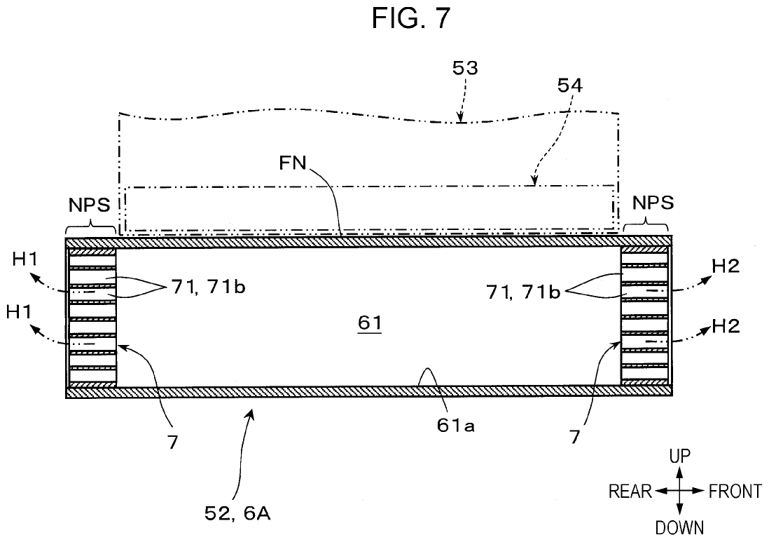

First, as shown in FIGS. 2 and 7, when the fixing operation is performed in the fixing device 5, the pressing rotation roller 52 rotates in contact with the fixing belt 53 heated when passing through the fixing section FN, so that the temperature at the outer peripheral surface of the pressing rotation roller 52 increases, as described above.

Especially in a case where the fixing operation is repeated and involves passing of multiple consecutive sheets of recording paper 9 having the same width, the temperature at the non-passing sections NPS on the pressing rotation roller 52 becomes higher than the temperature at the passing section PS, thus resulting in an increase in temperature variation.

On the other hand, the pressing rotation roller 52 in this case starts to rotate in the direction indicated by the arrow, as shown in FIGS. 2 and 3B, thus causing the heat dissipators 7 to rotate together accordingly.

Moreover, the air blower 58 is actuated, so that the air E is blown onto the pressing rotation roller 52.

Accordingly, in the pressing rotation roller 52, the heat that the pressing rotation roller 52 has is efficiently conducted to the two heat dissipators 7 having the tubular dense structure disposed in contact with the inner peripheral surface 61a at the opposite ends of the internal space 61.

Then, in the pressing rotation roller 52, heat H1 and heat H2 conducted to the two heat dissipators 7 are released outward from the pressing rotation roller 52 via the tubular bodies 71 and the through-spaces 71b of the heat dissipators 7, as shown in FIG. 4.

Accordingly, the pressing rotation roller 52 including the roller 6A is cooled by the heat dissipating function of the heat dissipators 7.

In this case, since the heat dissipators 7 have the tubular dense structure (i.e., the honeycomb structure in this example) composed of aluminum, efficient heat dissipation may be performed, as compared with a case where the heat dissipators 7 are composed of another metal.

With regard to the pressing rotation roller 52, the sections where the heat dissipators 7 are disposed, that is, the non-passing sections NPS, are cooled relatively efficiently.

Moreover, the cooling of the pressing rotation roller 52 including the roller 6A having the heat dissipators 7 does not involve any rotationally-driven component for the cooling operation, so that noise, such as operating noise, does not occur, whereby quietness may be ensured.

Therefore, in the pressing rotation roller 52 including the roller 6A having the heat dissipators 7, the roller 6A with the ensured quietness may be cooled even when the roller 6A, that is, the pressing rotation roller 52, increases in temperature as a result of receiving heat during the rotation thereof, as compared with a case where the heat dissipators 7 having the tubular dense structure are not disposed in at least a portion within the internal space 61 of the roller 6A in a state where the heat dissipators 7 are in contact with the inner peripheral surface 61a of the internal space 61.

In the pressing rotation roller 52 of the fixing device 5, the air E is directly blown onto the outer peripheral surface thereof from the air blower 58.

Accordingly, the pressing rotation roller 52 is also cooled by the air E blown from the air blower 58.

As described above, in the fixing device 5 according to the first exemplary embodiment, the pressing rotation roller 52 is cooled by the heat dissipating function of the heat dissipators 7 and is also cooled by the air blown from the air blower 58.

Furthermore, in the fixing device 5, the non-passing sections NPS on the pressing rotation roller 52 are cooled relatively efficiently so that a temperature variation in the axial direction J may be reduced, as compared with a case where the heat dissipators 7 are not disposed at the positions within the internal space 61 that correspond to the non-passing sections NPS on the pressing rotation roller 52.

Accordingly, in the fixing device 5, a wrinkle occurring in the recording paper 9 due to a temperature variation at the fixing section FN may be suppressed.

Consequently, in the image forming apparatus 1 equipped with the fixing device 5, a wrinkle occurring in the recording paper 9 may be suppressed at the fixing device 5, whereby a favorable image forming operation may be performed accordingly owing to the suppressed occurrence of a wrinkle.

### 1.7. Modifications of First Exemplary Embodiment

In the fixing device 5, the pressing rotation roller 52 including the roller 6A is cooled during the rotation thereof by the heat dissipating function of the heat dissipators 7, so that the volume of air E to be blown by the air blower 58 may be reduced.

In the fixing device 5 with this reduced volume of air, operating noise of the air blower 58 is relatively reduced, thereby achieving enhanced quietness during the cooling of the pressing rotation roller 52 accordingly.

Furthermore, in the configuration example of the fixing device 5, three rotating fans serving as the driving unit 582 of the air blower 58 are arranged in the axial direction J of the pressing rotation roller 52. Alternatively, the number of rotating fans may be reduced to two or one.

In the fixing device 5 with the reduced number of rotating fans in this manner, the operating noise of the air blower 58 is relatively reduced, thereby achieving enhanced quietness during the cooling of the pressing rotation roller 52 accordingly.

As another alternative, in the fixing device 5, for example, if there is a special condition, such as a low degree by which the pressing rotation roller 52 is to be cooled, the air blower 58 may be omitted.

In the fixing device 5 with the air blower 58 omitted in this manner, the operating noise of the air blower 58 is eliminated, thereby achieving enhanced quietness during the cooling operation of the pressing rotation roller 52 accordingly. In addition, in the fixing device 5 in this case, the installation space of the air blower 58 is not necessary, so that an increase in size of the fixing device 5 may be avoided. Moreover, in the fixing device 5 in this case, the pressing rotation roller 52 (i.e., the roller 6A) may be cooled without having other devices or components around the pressing rotation roller 52.

### Second Exemplary Embodiment

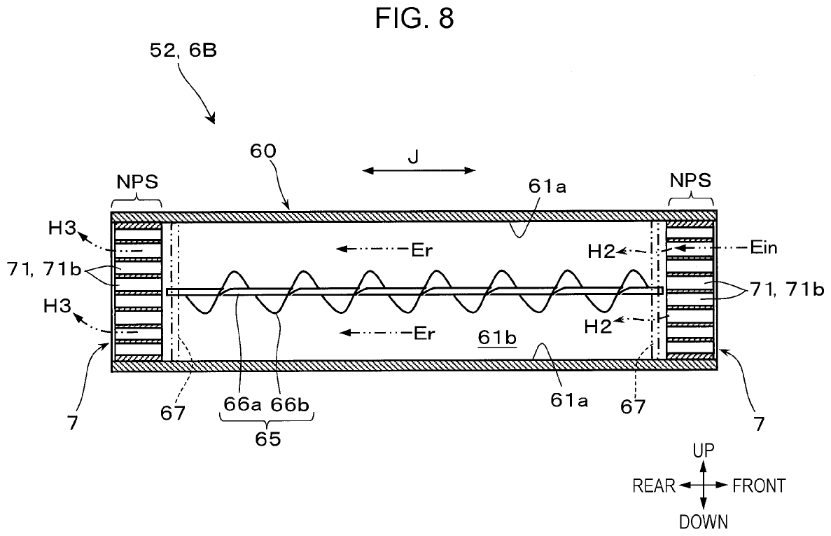

FIG. 8 is a cross-sectional view schematically illustrating a roller 6B serving as a pressing rotation roller 52 according to a second exemplary embodiment of the present disclosure.

The roller 6B according to the second exemplary embodiment is similar to the roller 6A according to the first exemplary embodiment except for an alteration in which an air blowing member 65 is added. The pressing rotation roller 52 including the roller 6B is applied to, for example, the fixing device 5 according to the first exemplary embodiment.

2.1. Configuration of Roller Equipped with Air Blowing Member

As shown in FIG. 8, the roller 6B serving as the pressing rotation roller 52 has the air blowing member 65 that is disposed in an inner partial space 61b where the heat dissipators 7 are not disposed in the internal space 61 of the roller body 60 and that causes a predetermined airflow Er to occur within the internal space 61 in conjunction with the rotation of the roller 6B.

As shown in FIG. 8, the air blowing member 65 according to the second exemplary embodiment is of a screw auger type having a support shaft 66a and a helical blade 66b extending helically around the outer peripheral surface of the support shaft 66a.

The support shaft 66a extends through the rotation axis of the roller 6B in the axial direction J of the roller 6B, and has opposite ends that are maintained at locations close to inner portions of the two heat dissipators 7.

The opposite ends of the support shaft 66a are fixed to shaft fixation members 67 securely disposed within the aforementioned partial space 61b of the internal space 61 of the roller 6B. The shaft fixation members 67 are rod-like members that may ensure a large gap so as to not to hinder a flow of air in the axial direction J within the internal space 61 of the roller 6B.

The helical blade 66b is provided at a predetermined height, a predetermined inclination, and a predetermined helical pitch around the outer peripheral surface of the support shaft 66a.

The helical direction and the inclination of the helical blade 66b are set in correspondence with the direction of the airflow Er to be generated in conjunction with the rotation of the roller 6B (i.e., the pressing rotation roller 52). The height and the helical pitch of the helical blade 66b are set in correspondence with the demanded flow speed of the airflow Er. The flow speed of the airflow Er preferably ranges between, for example, 0.05 m/s and 0.3 m/s.

As shown in FIG. 8, when the roller 6B (i.e., the pressing rotation roller 52) rotates, the air blowing member 65 according to the second exemplary embodiment generates the airflow Er flowing from the front side toward the rear side of the fixing device 5.

2.2. Operation of Roller Equipped with Air Blowing Member

For example, in a case where the pressing rotation roller 52 including the roller 6B according to the second exemplary embodiment is applied to the fixing device 5 according to the first exemplary embodiment, when a timing for performing the above-described image forming operation is reached, the following cooling operation is performed in the roller 6B serving as a rotating body.

Specifically, the pressing rotation roller 52 including the roller 6B starts to rotate in the direction indicated by the arrow (see FIG. 2) in the fixing device 5, thus causing the heat dissipators 7 and the air blowing member 65 to rotate together.

Furthermore, the air blower 58 is actuated, so that the air E is blown onto the pressing rotation roller 52.

Accordingly, the pressing rotation roller 52 is similar to the case described in the first exemplary embodiment in that the heat particularly in the non-passing sections NPS is efficiently conducted to the two heat dissipators 7 having the tubular dense structure, and the conducted heat is released outward from the pressing rotation roller 52.

Furthermore, at the pressing rotation roller 52, the air blowing member 65 moves to rotate around the support shaft 66a in conjunction with the rotation of the pressing rotation roller 52. Therefore, the helical blade 66b of the air blowing member 65 causes the airflow Er flowing in the direction indicated in FIG. 8 to occur within the aforementioned partial space 61b in the internal space 61 of the pressing rotation roller 52. In this case, the airflow Er flows from the front side toward the rear side of the fixing device 5.

In this case, the airflow Er occurs as a result of movement of the air within the internal space 61 of the pressing rotation roller 52 (i.e., the roller 6B). Moreover, the airflow Er causes air Ein outside the pressing rotation roller 52 to newly flow in through the heat dissipator 7 (i.e., the through-spaces 71b) located at the front end of the roller.

Accordingly, heat H2 and heat H3 conducted to the two heat dissipators 7 are transferred by receiving the effect of the airflow Er, and are efficiently released rearward through the heat dissipator 7 located at the rear end of the roller. With the occurrence of the air Ein flowing in from the outside due to the airflow Er, the heat dissipating function of the heat dissipators 7 is enhanced, whereby the cooling efficiency of the pressing rotation roller 52 may also be enhanced.

Consequently, the pressing rotation roller 52 including the roller 6B is cooled by the heat dissipating function of the heat dissipators 7, and the heat dissipating function of the heat dissipators 7 and the cooling of the pressing rotation roller 52 are enhanced in a subsidiary fashion by the airflow generated by the air blowing member 65.

In a fixing device to which the pressing rotation roller 52 including the roller 6B according to the second exemplary embodiment is applied, the pressing rotation roller 52 is cooled by the heat dissipating function of the heat dissipators 7 and by the air blown by the air blower 58, similar to the case of the fixing device 5 according to the first exemplary embodiment.

In addition, in this fixing device, the roller 6B may be efficiently cooled during the rotation thereof, as compared with a case where the air blowing member 65 is not disposed within the internal space 61 of the roller 6B serving as the pressing rotation roller 52.

### Third Exemplary Embodiment

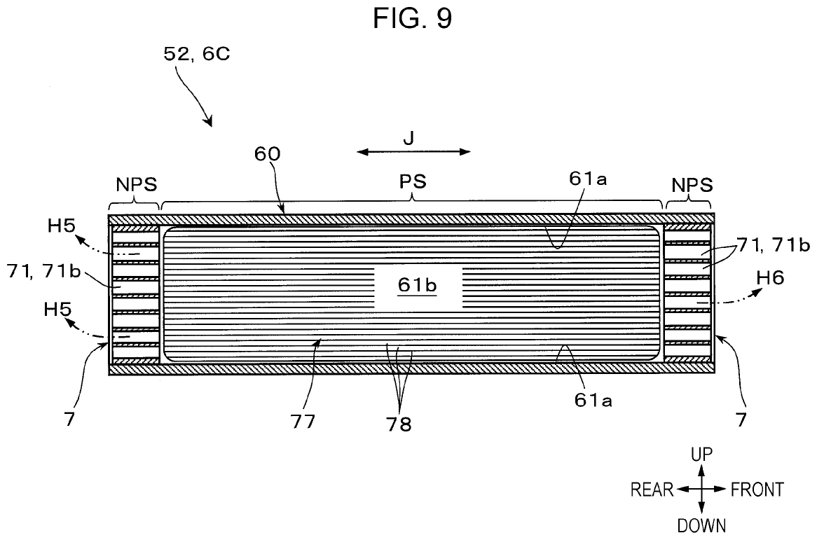

FIG. 9 is a cross-sectional view schematically illustrating a roller 6C serving as a pressing rotation roller 52 according to a third exemplary embodiment of the present disclosure.

The roller 6C according to the third exemplary embodiment is similar to the roller 6A according to the first exemplary embodiment except for an alteration in which a second heat dissipator 77 is added. The pressing rotation roller 52 including the roller 6C is applied to, for example, the fixing device 5 according to the first exemplary embodiment.

3.1. Configuration of Roller Equipped with Second Heat Dissipator

As shown in FIG. 9, the roller 6C serving as the pressing rotation roller 52 has the second heat dissipator 77 having a tubular dense structure that is disposed in the inner partial space 61b where the heat dissipators 7 are not disposed in the internal space 61 of the roller body 60 and that is composed of a material with lower thermal conductivity than the heat dissipators 7.

The second heat dissipator 77 having the tubular dense structure according to the third exemplary embodiment is a member having a tubular dense structure, such as a honeycomb structure, composed of a metallic material with lower thermal conductivity than aluminum or a non-metallic material, such as paper, fiber-reinforced plastic, or aramid.

As shown in FIG. 9, the second heat dissipator 77 having the tubular dense structure is disposed such that through-spaces 78 of the tubular dense structure extend in the axial direction J of the roller 6C and openings at the opposite ends of the through-spaces 78 face the heat dissipators 7.

Similar to the heat dissipators 7, the second heat dissipator 77 is disposed in contact with the inner peripheral surface 61a of the internal space 61. Similar to the heat dissipators 7, the second heat dissipator 77 may be provided with the outer peripheral body 74 (see FIG. 5) or does not have to be provided with the outer peripheral body 74.

Furthermore, from the standpoint of avoiding uneven cooling of the roller 6C in the axial direction J, the second heat dissipator 77 may be disposed entirely in the aforementioned partial space 61b of the internal space 61, as shown in FIG. 9. The second heat dissipator 77 in this case is disposed within the internal space 61 corresponding to the passing section PS on the pressing rotation roller 52.

3.2. Operation of Roller Equipped with Second Heat Dissipator

For example, in a case where the pressing rotation roller 52 including the roller 6C according to the third exemplary embodiment is applied to the fixing device 5 according to the first exemplary embodiment, when a timing for performing the above-described image forming operation is reached, the following cooling operation is performed in the roller 6C serving as a rotating body.

Specifically, the pressing rotation roller 52 including the roller 6C starts to rotate in the direction indicated by the arrow (see FIG. 2) in the fixing device 5, thus causing the heat dissipators 7 and the second heat dissipator 77 to rotate together.

Furthermore, the air blower 58 is actuated, so that the air E is blown onto the pressing rotation roller 52.

Accordingly, the pressing rotation roller 52 is similar to the case described in the first exemplary embodiment in that the heat particularly in the non-passing sections NPS is efficiently conducted to the two heat dissipators 7 having the tubular dense structure, and the conducted heat is released outward from the pressing rotation roller 52.

Furthermore, at the pressing rotation roller 52, the heat particularly in the non-passing sections NPS is conducted to the second heat dissipator 77, and the heat conducted to the second heat dissipator 77 is released outward as heat H5 and heat H6 from the pressing rotation roller 52 via the heat dissipators 7.

Consequently, the pressing rotation roller 52 including the roller 6C is cooled by the heat dissipating function of the heat dissipators 7, and is also cooled in a subsidiary fashion by the heat dissipating function of the second heat dissipator 77.

In a fixing device to which the pressing rotation roller 52 including the roller 6C according to the third exemplary embodiment is applied, the pressing rotation roller 52 is cooled by the heat dissipating function of the heat dissipators 7 and by the air blown by the air blower 58, similar to the case of the fixing device 5 according to the first exemplary embodiment.

In addition, in this fixing device, the roller 6C may be efficiently cooled during the rotation thereof, as compared with a case where the second heat dissipator 77 is not disposed within the internal space 61 of the roller 6C serving as the pressing rotation roller 52.

### Fourth Exemplary Embodiment

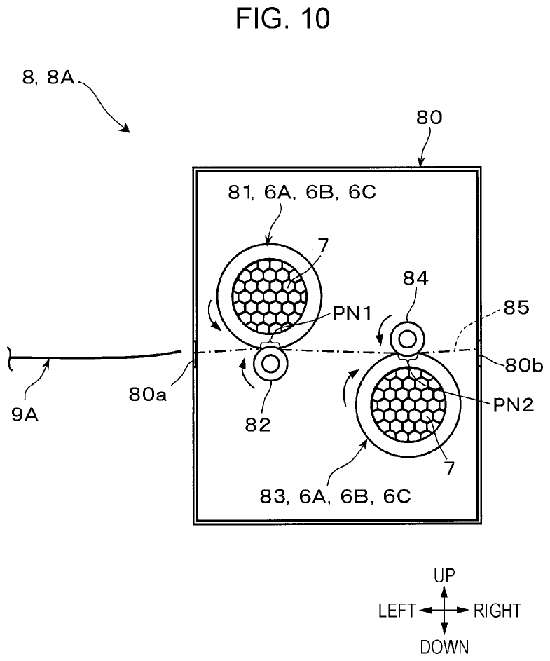

FIG. 10 schematically illustrates an uncurling device 8A as an example of a medium adjustment device 8 according to a fourth exemplary embodiment of the present disclosure.

### 4.1. Configuration of Uncurling Device

The uncurling device 8A causes recording paper 9A as an example of a recording medium that has increased in temperature and is curled as a result of receiving heat from the outside to pass through rotation rollers while being in contact therewith so as to substantially uncurl the recording paper 9A.

The uncurling device 8A according to the fourth exemplary embodiment includes a first pressing nip PN1, a second pressing nip PN2, and a transport path 85 for the recording paper 9A that are provided inside a housing 80.

The housing 80 is a box-shaped structure provided with an inlet 80a and an outlet 80b for the recording paper 9A.

The first pressing nip PN1 presses against the recording paper 9A and allows the recording paper 9A to pass therethrough in a state where the recording paper 9A is curved upward.

The first pressing nip PN1 is where a first rotation roller 81 and a first pressing roller 82 are in contact with each other. The first rotation roller 81 rotates in a direction indicated by an arrow. The first pressing roller 82 rotates in a direction indicated by an arrow by being in pressure contact with a substantially lowermost outer peripheral surface of the first rotation roller 81.

The first rotation roller 81 has an elastic surface layer (not shown) and rotates in the direction indicated by the arrow by receiving a rotational driving force from a driving device (not shown). The first pressing roller 82 is a rigid roller having higher rigidity than the elastic surface layer of the first rotation roller 81 and rotates in the direction indicated by the arrow by being driven by the rotation of the first rotation roller 81.

The second pressing nip PN2 presses against the recording paper 9A that has passed through the first pressing nip PN1 and allows the recording paper 9A to pass therethrough in a state where the recording paper 9A is curved downward.

The second pressing nip PN2 is where a second rotation roller 83 and a second pressing roller 84 are in contact with each other. The second rotation roller 83 rotates in a direction indicated by an arrow. The second pressing roller 84 rotates in a direction indicated by an arrow by being in pressure contact with a substantially uppermost outer peripheral surface of the second rotation roller 83.

The second rotation roller 83 has an elastic surface layer (not shown) and rotates in the direction indicated by the arrow by receiving a rotational driving force from a driving device (not shown). The second pressing roller 84 is a rigid roller having higher rigidity than the elastic surface layer of the second rotation roller 83 and rotates in the direction indicated by the arrow by being driven by the rotation of the second rotation roller 83.

The transport path 85 allows the recording paper 9A introduced through the inlet 80a of the housing 80 to pass through the first pressing nip PN1 and the second pressing nip PN2 in this order, and subsequently allows the recording paper 9A to be output from the outlet 80b of the housing 80.

The transport path 85 is constituted of, for example, a transport guide member (not shown) that guides the recording paper 9A in the transport direction thereof.

### 4.2. Operation of Uncurling Device

When the uncurling device 8A is actuated, the first rotation roller 81 and the second rotation roller 83 start to rotate in the respective directions indicated by the arrows. Moreover, in the uncurling device 8A, the first pressing roller 82 and the second pressing roller 84 are rotationally driven by being in contact in an engaged fashion to predetermined depths with the elastic surface layer of the first rotation roller 81 and the elastic surface layer of the second rotation roller 83, respectively.

Then, in the uncurling device 8A, the recording paper 9A is introduced into the housing 80 and is transported along the transport path 85 to pass through the first pressing nip PN1 and the second pressing nip PN2 in this order.

In this case, the recording paper 9A is pressed onto the first rotation roller 81 from below by the first pressing roller 82 at the first pressing nip PN1, so as to pass therethrough in a state where the recording paper 9A is temporarily curved upward. With regard to the recording paper 9A, for example, a curled part thereof curved downward is corrected.

The recording paper 9A that has passed through the first pressing nip PN1 is pressed onto the second rotation roller 83 from below by the second pressing roller 84 at the second pressing nip PN2, so as to pass therethrough in a state where the recording paper 9A is temporarily curved downward. With regard to the recording paper 9A, for example, a curled part thereof curved upward is corrected.

Accordingly, the curled recording paper 9A prior to being introduced to the uncurling device 8A is substantially uncurled as a result of the recording paper 9A passing through the first pressing nip PN1 and the second pressing nip PN2 of the uncurling device 8A.

For example, in order to eliminate curl existing in recording paper 9 to be output from a fixing device in an image forming apparatus, the uncurling device 8A is disposed within a sheet transport path located downstream in the transport direction of the recording paper 9 in the fixing device. The recording paper 9 introduced to the uncurling device 8A in this usage example has an image fixed thereon at the fixing device.

If the recording paper 9A that has increased in temperature and is curled as a result of receiving heat from the outside exists independently, the uncurling device 8A may be used as an independent device.

### 4.3. Configuration Related to Cooling of Rotation Rollers

As shown in FIG. 10, in the uncurling device 8A, each of the first rotation roller 81 and the second rotation roller 83 includes the roller 6A equipped with the heat dissipator 7 having the tubular dense structure.

Each of the first rotation roller 81 and the second rotation roller 83 includes the heat dissipator 7 having the tubular dense structure that is disposed in at least a portion within the internal space 61 of the cylindrical roller body 60 in a state where the heat dissipator 7 is in contact with the inner peripheral surface 61a of the internal space 61 (see FIGS. 3A to 4).

The heat dissipator 7 having the tubular dense structure is substantially similar to each heat dissipator 7 according to the first exemplary embodiment.

In each of the first rotation roller 81 and the second rotation roller 83, the heat dissipator 7 is disposed in a portion within the internal space 61 that corresponds to a relatively high temperature area.

In detail, in each of the first rotation roller 81 and the second rotation roller 83, the heat dissipator 7 may be disposed in a portion within the internal space 61 that corresponds to an area through which the recording paper 9A passes while being in contact therewith. Although the heat dissipator 7 in this case is disposed as a single heat dissipator in a portion within the internal space 61, the heat dissipator 7 may alternatively be multiple split heat dissipators disposed in contact with each other or disposed with a distance therebetween in the axial direction J.

As another alternative, in each of the first rotation roller 81 and the second rotation roller 83, the heat dissipator 7 may be disposed in the area through which the recording paper 9A passes while being in contact therewith and only at each of the opposite ends of the aforementioned area in the axial direction J.

### 4.4. Operation Related to Cooling of Rotation Rollers

When the uncurling device 8A is actuated, the first rotation roller 81 and the second rotation roller 83 are cooled as follows.

First, in the uncurling device 8A, the recording paper 9A that has increased in temperature and is curled as a result of receiving heat from the outside passes through the first pressing nip PN1 and the second pressing nip PN2 that are rotating.

Therefore, the first rotation roller 81 at the first pressing nip PN1 and the second rotation roller 83 at the second pressing nip PN2 through which the recording paper 9A passes while being in contact therewith receive heat from the recording paper 9A, so that the temperature of the outer peripheral surface of each roller is higher than the temperature when the uncurling device 8A is stopped.

Furthermore, at each of the first rotation roller 81 and the second rotation roller 83, the heat dissipator 7 disposed within the internal space 61 thereof rotates together.

Accordingly, at each of the first rotation roller 81 and the second rotation roller 83, the heat particularly in the area through which the recording paper 9A passes while being in contact therewith is efficiently conducted to the heat dissipator 7 having the tubular dense structure, and the conducted heat is released outward from each of the first rotation roller 81 and the second rotation roller 83.

Specifically, the first rotation roller 81 and the second rotation roller 83 each including the roller 6A are cooled by the heat dissipating function of the heat dissipators 7 having the tubular dense structure. Since this cooling does not involve any driven components for exclusively cooling the first rotation roller 81 and the second rotation roller 83, noise, such as operating noise, does not occur.

Therefore, in the uncurling device 8A equipped with the first rotation roller 81 and the second rotation roller 83 each including the roller 6A, the rollers 81 and 83 with the ensured quietness may be cooled even when the first rotation roller 81 and the second rotation roller 83 increase in temperature during the rotation thereof as a result of receiving heat from the recording paper 9A, as compared with a case where the heat dissipators 7 having the tubular dense structure are not disposed within the internal spaces of the rollers 81 and 83.

### Fifth Exemplary Embodiment

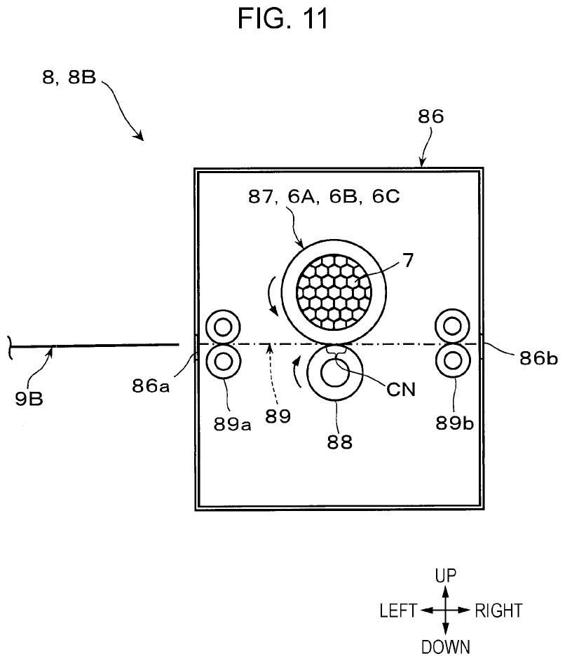

FIG. 11 schematically illustrates a medium cooling device 8B as another example of a medium adjustment device 8 according to a fifth exemplary embodiment of the present disclosure.

### 5.1. Configuration of Medium Cooling Device

The medium cooling device 8B causes recording paper 9B as an example of a recording medium that has increased in temperature as a result of receiving heat from the outside to pass through a rotating body while being in contact therewith, so as to cool the recording paper 9B to a temperature lower than the increased temperature.

The medium cooling device 8B according to the fifth exemplary embodiment includes a cooling section CN and a transport path 89 for the recording paper 9B that are provided inside a housing 86.

The housing 86 is a box-shaped structure provided with an inlet 86a and an outlet 86b for the recording paper 9B.

The cooling section CN transports the recording paper 9B in a nipped state and cools the recording paper 9B.

The cooling section CN is where a cooling rotation roller 87 and a transport rotation roller 88 are in contact with each other. The cooling rotation roller 87 rotates in a direction indicated by an arrow. The transport rotation roller 88 rotates in a direction indicated by an arrow by being in contact with the outer peripheral surface of the cooling rotation roller 87.

The cooling rotation roller 87 is composed of a material with high thermal conductivity, such as metal, and rotates in the direction indicated by the arrow by receiving a rotational driving force from a driving device (not shown). The transport rotation roller 88 has an elastic surface layer (not shown) and rotates in the direction indicated by the arrow by being driven by the rotation of the cooling rotation roller 87.

The transport path 89 allows the recording paper 9B introduced through the inlet 86a of the housing 86 to pass through the cooling section CN, and subsequently allows the recording paper 9B to be output from the outlet 86b of the housing 86.

The transport path 89 is constituted of, for example, a pair of transport rollers 89a and 89b that nip and transport the recording paper 9B and a transport guide member (not shown) that guides the recording paper 9B in the transport direction thereof.

### 5.2. Operation of Medium Cooling Device

When the medium cooling device 8B is actuated, the cooling rotation roller 87 and the pair of transport rollers 89a and 89b start to rotate in predetermined directions. Moreover, in the medium cooling device 8B, the transport rotation roller 88 starts to rotate by being driven by being in contact with the cooling rotation roller 87.

Then, in the medium cooling device 8B, the recording paper 9B is introduced into the housing 86 and is transported along the transport path 89 to pass through the cooling section CN.

In this case, the recording paper 9B is transported by being nipped between the cooling rotation roller 87 and the transport rotation roller 88 at the cooling section CN.

Accordingly, the recording paper 9B passes the cooling rotation roller 87 while being in contact therewith, so that the heat of the recording paper 9B is conducted to the cooling rotation roller 87, whereby the recording paper 9B is cooled.

For example, the medium cooling device 8B is used by being disposed within a transport path for a recording medium in an image forming apparatus. The recording paper 9B is not limited to recording paper having an image formed thereon, and may alternatively be recording paper prior to having an image formed thereon. Moreover, the recording paper 9B may be long strip-like recording paper (such as rolled paper).

If the recording paper 9B that has increased in temperature as a result of receiving heat from the outside exists independently, the medium cooling device 8B may be used as an independent device.

### 5.3. Configuration Related to Cooling of Rotation Roller

As shown in FIG. 11, in the medium cooling device 8B, the cooling rotation roller 87 includes the roller 6A equipped with the heat dissipator 7 having the tubular dense structure.

The cooling rotation roller 87 includes the heat dissipator 7 having the tubular dense structure that is disposed in at least a portion within the internal space 61 of the cylindrical roller body 60 in a state where the heat dissipator 7 is in contact with the inner peripheral surface 61a of the internal space 61 (see FIGS. 3A to 4).

The heat dissipator 7 having the tubular dense structure is substantially similar to each heat dissipator 7 according to the first exemplary embodiment.

The heat dissipator 7 is disposed in a portion within the internal space 61 that corresponds to a relatively high temperature area.

In detail, in the cooling rotation roller 87, the heat dissipator 7 may be disposed in a portion within the internal space 61 that corresponds to an area through which the recording paper 9B passes while being in contact therewith. Although the heat dissipator 7 in this case is disposed as a single heat dissipator in a portion within the internal space 61, the heat dissipator 7 may alternatively be multiple split heat dissipators disposed in contact with each other or disposed with a distance between in the axial direction J.

As another alternative, in the cooling rotation roller 87, the heat dissipator 7 may be disposed in the area through which the recording paper 9B passes while being in contact therewith and only at each of the opposite ends of the aforementioned area in the axial direction J.

### 5.4. Operation Related to Cooling of Rotation Roller

When the medium cooling device 8B is actuated, the cooling rotation roller 87 is cooled as follows.

First, in the medium cooling device 8B, the recording paper 9B that has increased in temperature as a result of receiving heat from the outside passes through the cooling section CN.

Therefore, the cooling rotation roller 87 at the cooling section CN through which the recording paper 9B passes while being in contact therewith receives heat from the recording paper 9B, so that the temperature of the outer peripheral surface of the cooling rotation roller 87 is higher than the temperature when the medium cooling device 8B is stopped.

Furthermore, at the cooling rotation roller 87, the heat dissipator 7 disposed within the internal space 61 thereof rotates together.

Accordingly, at the cooling rotation roller 87, the heat particularly in the area through which the recording paper 9B passes while being in contact therewith is efficiently conducted to the heat dissipator 7 having the tubular dense structure, and the conducted heat is released outward from the cooling rotation roller 87.

Specifically, the cooling rotation roller 87 including the roller 6A is cooled by the heat dissipating function of the heat dissipator 7 having the tubular dense structure. Since this cooling does not involve any driven component for exclusively cooling the cooling rotation roller 87, noise, such as operating noise, does not occur.

Therefore, in the medium cooling device 8B equipped with the cooling rotation roller 87 including the roller 6A, the cooling rotation roller 87 with the ensured quietness may be cooled even when the cooling rotation roller 87 increases in temperature during the rotation thereof as a result of receiving heat from the recording paper 9B, as compared with a case where the heat dissipator 7 having the tubular dense structure is not disposed within the internal space of the cooling rotation roller 87.

### Modifications

The exemplary embodiments of the present disclosure are not limited to the first to fifth exemplary embodiments described above, and various modifications and alterations are permissible so long as they do not alter the gist defined in the claims. Therefore, for example, the exemplary embodiments of the present disclosure encompass the following modifications.

In the fixing device 5 according to the first exemplary embodiment, the heating rotating body 51 used may be of a roller type (i.e., a heating rotation roller).

Although the air blowing member 65 in the roller 6B according to the second exemplary embodiment is of a type provided with the helical blade 66b extending helically and continuously around the support shaft 66a, the air blowing member 65 is not limited to this type.

The air blowing member 65 of another type may include tabular air blowing members disposed at a predetermined pitch on the support shaft 66a. As another alternative, the air blowing member 65 of another type may be an air blowing protrusion protruding from the inner peripheral surface 61a of the internal space 61 in the roller body 60 toward the rotation axis. The air blowing protrusion in this case may be composed of a material having thermal conductivity.

Although the third exemplary embodiment relates to a configuration example where the second heat dissipator 77 is disposed entirely in the partial space 61b where the heat dissipators 7 do not exist in the internal space 61 of the roller 6C, the second heat dissipator 77 may be disposed, for example, only in a partial region near the heat dissipators 7 within the aforementioned partial space 61b.

This configuration is effective when, for example, an area of the roller 6C slightly inward of the heat dissipators 7 tends to be relatively high in temperature, since this inward area may be locally cooled by the second heat dissipator 77.

In the uncurling device 8A according to the fourth exemplary embodiment, the first rotation roller 81 and the second rotation roller 83 may each include the roller 6B or 6C (see FIG. 8 or 9) described in the second or third exemplary embodiment in place of the roller 6A.

Furthermore, in the uncurling device 8A, one of the first rotation roller 81 and the second rotation roller 83 may include any one of the rollers 6A, 6B, and 6C.

Moreover, the uncurling device 8A may have the first pressing nip PN1 and the second pressing nip PN2 arranged in the reversed order in the transport direction of the recording paper 9A. The uncurling device 8A may include only one of the first pressing nip PN1 and the second pressing nip PN2.

In the medium cooling device 8B according to the fifth exemplary embodiment, the roller 6A may be replaced with the roller 6B or 6C (see FIG. 8 or 9) described in the second or third exemplary embodiment.

Moreover, the cooling section CN disposed in the medium cooling device 8B may include multiple cooling sections CN. Furthermore, the cooling section CN in the medium cooling device 8B may have a positional relationship in which the cooling rotation roller 87 and the transport rotation roller 88 are positionally inverted in the vertical direction.

An image forming apparatus equipped with the fixing device 5 may be an image forming apparatus equipped with the image forming section 2 that employs a direct transfer technique involving directly transferring an unfixed image onto the recording paper 9, instead of the image forming section 2 using the intermediate transfer unit 30, that is, an intermediate transfer technique.

An image forming apparatus equipped with the medium adjustment device 8, as represented by the uncurling device 8A or the medium cooling device 8B, may be an image forming apparatus that employs an image forming technique other than the technique involving forming an unfixed image formed of a developer. An image forming technique other than the technique involving forming an unfixed image formed of a developer is, for example, an inkjet-based image forming technique.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))) A cylindrical roller that is used by being rotated, the roller comprising a heat dissipator having a tubular dense structure and disposed in at least a portion within an internal space of the roller in a state where the heat dissipator is in contact with an inner peripheral surface of the internal space.

(((2))) The roller according to (((1))), wherein the heat dissipator is composed of metal with higher thermal conductivity than the inner peripheral surface of the internal space.

(((3))) The roller according to (((2))), wherein the metal is aluminum.

(((4))) The roller according to any one of (((1))) to (((3))), wherein the heat dissipator is disposed at each of opposite ends of the internal space in an axial direction.

(((5))) The roller according to (((4))), further comprising an air blowing member that is disposed in an inner portion where the heat dissipators are not disposed in the internal space and that causes an airflow to occur within the internal space in conjunction with rotation of the roller.

(((6))) The roller according to (((5))), wherein the air blowing member causes the airflow to flow from a first end toward a second end of the internal space.

(((7))) The roller according to (((4))), further comprising a second heat dissipator having a tubular dense structure that is disposed in an inner portion where the heat dissipators are not disposed in the internal space and that is composed of a material with lower thermal conductivity than the heat dissipator.

(((8))) A fixing device comprising:
a heating rotating body that has a heater; and
a pressing rotation roller that is in contact with the heating rotating body while applying pressure thereto and that forms a fixing section through which a recording medium retaining an unfixed image passes,
wherein the pressing rotation roller includes the roller according to any one of (((1))) to (((7))).

(((9))) The fixing device according to (((8))), wherein the heat dissipator is disposed within an internal space corresponding to a non-passing section on the pressing rotation roller, the non-passing section being where the recording medium does not pass through in contact with the pressing rotation roller.

(((10))) A medium adjustment device comprising:
a rotation roller that allows a recording medium increased in temperature to pass while being in contact therewith so as to adjust the recording medium,
wherein the rotation roller includes the roller according to any one of (((1))) to (((7))).

(((11))) An image forming apparatus comprising:
an image forming section that forms an unfixed image and transfers the unfixed image onto a recording medium; and
a fixing device that fixes the unfixed image transferred at the image forming section onto the recording medium,
wherein the fixing device includes the fixing device according to (((8))).

(((12))) An image forming apparatus comprising:
a medium adjustment device that allows a recording medium increased in temperature to pass through a rotating body while being in contact therewith so as to adjust the recording medium,
wherein the medium adjustment device includes the medium adjustment device according to (((10))).

What is claimed is:

1. A cylindrical roller that is used by being rotated, the roller comprising:
a heat dissipator having a tubular dense structure and disposed in at least a portion within an internal space of the roller in a state where the heat dissipator is in contact with an inner peripheral surface of the internal space.

2. The roller according to claim 1,
wherein the heat dissipator is composed of metal with higher thermal conductivity than the inner peripheral surface of the internal space.

3. The roller according to claim 2,
wherein the metal is aluminum.

4. The roller according to claim 1,
wherein the heat dissipator is disposed at each of opposite ends of the internal space in an axial direction.

5. The roller according to claim 4, further comprising:
an air blowing member that is disposed in an inner portion where the heat dissipators are not disposed in the internal space and that causes an airflow to occur within the internal space in conjunction with rotation of the roller.

6. The roller according to claim 5,
wherein the air blowing member causes the airflow to flow from a first end toward a second end of the internal space.

7. The roller according to claim 4, further comprising:
a second heat dissipator having a tubular dense structure that is disposed in an inner portion where the heat dissipators are not disposed in the internal space and that is composed of a material with lower thermal conductivity than the heat dissipator.

8. A fixing device comprising:
a heating rotating body that has a heater; and
a pressing rotation roller that is in contact with the heating rotating body while applying pressure thereto and that forms a fixing section through which a recording medium retaining an unfixed image passes,
wherein the pressing rotation roller includes the roller according to claim 1.

9. A fixing device comprising:
a heating rotating body that has a heater; and
a pressing rotation roller that is in contact with the heating rotating body while applying pressure thereto and that forms a fixing section through which a recording medium retaining an unfixed image passes,
wherein the pressing rotation roller includes the roller according to claim 2.

10. A fixing device comprising:
a heating rotating body that has a heater; and
a pressing rotation roller that is in contact with the heating rotating body while applying pressure thereto and that forms a fixing section through which a recording medium retaining an unfixed image passes,
wherein the pressing rotation roller includes the roller according to claim 3.

11. A fixing device comprising:
a heating rotating body that has a heater; and
a pressing rotation roller that is in contact with the heating rotating body while applying pressure thereto and that forms a fixing section through which a recording medium retaining an unfixed image passes,
wherein the pressing rotation roller includes the roller according to claim 4.

12. A fixing device comprising:
a heating rotating body that has a heater; and
a pressing rotation roller that is in contact with the heating rotating body while applying pressure thereto and that forms a fixing section through which a recording medium retaining an unfixed image passes,
wherein the pressing rotation roller includes the roller according to claim 5.

13. A fixing device comprising:
a heating rotating body that has a heater; and
a pressing rotation roller that is in contact with the heating rotating body while applying pressure thereto and that forms a fixing section through which a recording medium retaining an unfixed image passes,
wherein the pressing rotation roller includes the roller according to claim 6.

14. A fixing device comprising:
a heating rotating body that has a heater; and
a pressing rotation roller that is in contact with the heating rotating body while applying pressure thereto and that forms a fixing section through which a recording medium retaining an unfixed image passes,
wherein the pressing rotation roller includes the roller according to claim 7.

15. The fixing device according to claim 8,
wherein the heat dissipator is disposed within an internal space corresponding to a non-passing section on the pressing rotation roller, the non-passing section being where the recording medium does not pass through in contact with the pressing rotation roller.

16. The fixing device according to claim 9,
wherein the heat dissipator is disposed within an internal space corresponding to a non-passing section on the pressing rotation roller, the non-passing section being where the recording medium does not pass through in contact with the pressing rotation roller.

17. The fixing device according to claim 10,
wherein the heat dissipator is disposed within an internal space corresponding to a non-passing section on the pressing rotation roller, the non-passing section being where the recording medium does not pass through in contact with the pressing rotation roller.

18. A medium adjustment device comprising:
a rotation roller that allows a recording medium increased in temperature to pass while being in contact therewith so as to adjust the recording medium,
wherein the rotation roller includes the roller according to claim 1.

19. An image forming apparatus comprising:
an image forming section that forms an unfixed image and transfers the unfixed image onto a recording medium; and
a fixing device that fixes the unfixed image transferred at the image forming section onto the recording medium,
wherein the fixing device includes the fixing device according to claim 8.

20. An image forming apparatus comprising:
a medium adjustment device that allows a recording medium increased in temperature to pass through a rotating body while being in contact therewith so as to adjust the recording medium,
wherein the medium adjustment device includes the medium adjustment device according to claim 18.
